(19) United States
(12) Patent Application Publication
(10) Pub. No.: US 2014/0057729 A1
(43) Pub. Date: Feb. 27, 2014

(54) TORQUE TRANSFER DEVICE

(71) Applicant: Schaeffler Technologies AG & Co. KG, Herzogenaurach (DE)

(72) Inventor: Eugen Kombowski, Malsch (DE)

(21) Appl. No.: 14/071,872

(22) Filed: Nov. 5, 2013

Related U.S. Application Data
(63) Continuation of application No. PCT/DE2012/000451, filed on May 3, 2012.

(30) Foreign Application Priority Data
May 13, 2011 (DE) 102011101596.9

(51) Int. Cl. F16D 3/12

(52) U.S. Cl. CPC F16D 3/12
USPC 464/61.1

(57) ABSTRACT

A torque transfer device in a drive train, having an input component, which can rotate about a rotational axis and can be connected to a drive side; an output component, which is capable of limited rotation in relation to the input component counter to the action of at least one helical spring and which can be connected to an output side; and having a spring hanger component, which radially delimits the exterior of the helical spring. The helical spring has a wire, which is wound around a spring axis and sections of which are formed on to a radially exterior region in relation to the rotational axis along the spring axis. The cross-section of the wire is substantially circular and the circumference of the cross-section can he described by a first wire radius.

### CROSS-REFERENCE TO RELATED APPLICATIONS

This patent is filed under 35 U.S.C. §120 and §365(c) as a continuation of International Patent Application No. PCT/DE2012/000451 tiled May 3, 2012, which application claims priority from German Patent Application No. 10 2011 101 596.9 filed May 13, 2011, which applications are incorporated herein by reference in their entireties.

### FIELD OF THE INVENTION

The invention relates to a torque transfer device.

### BACKGROUND OF THE INVENTION

International Patent Application No. 2007/006255 discloses a torque transmission device designed as a dual mass flywheel in a drive train, having an input component, which can rotate around a rotational axis and can be connected to a drive side, and an output component, which is capable of limited rotation in relation to the input component counter to the action of at least one helical spring and which can be connected to an output side. The helical spring has a wire, which is wound around a spring axis, the wire having a circular shape, i.e., a circular cross-section. Alternatively, and to reduce the wear between the helical spring and a spring hanger component, which retains the helical spring and is designed as a supporting tray, the wire can include extensive sections formed on to a radially exterior and interior region.

### BRIEF SUMMARY OF THE INVENTION

The object of the invention is to reduce the contact between the spring hanger component and the helical spring. Moreover, the objective is to further reduce the wear between the spring hanger component and the helical spring.

Accordingly, a torque transfer device in a drive train, having an input component, which can rotate around a rotational axis and can be connected to a drive side and an output component, which is capable of limited rotation in relation to the input component counter to the action of at least one helical spring, which can be connected to an output side, and having a spring hanger component, which radially delimits the exterior of the helical spring is proposed, where the helical spring has a wire, which is wound around a spring axis, where sections of the wire are formed on to a radially exterior region in relation to the rotational axis along the spring axis, and the cross-section of the wire is essentially circular and its circumference can be described by a first wire radius, and where sections of the formed on wire in the direction of the circumference of the wire cross-section are round and can be described by a second wire radius, where the first wire radius and the second wire radius are different from one another. This helps reduce the contact and the contact pressure as well as the wear between the spring hanger component and the helical spring.

In an embodiment, the first wire radius is smaller than the second wire radius. For example, the second wire radius is greater than or equal to three times the first wire radius,

in another embodiment, the helical spring is designed as a bow spring or as a compression spring.

In yet another embodiment, the spring hanger component has a curvature in a section which is radially facing the helical spring, the curvature matching the second wire radius.

In yet another embodiment, a supporting surface is formed between the spring hanger component and the formed on wire, where the amount of the supporting surface remains constant in a first direction of rotation with a limited rotation of the wire relative to the spring hanger component in an axis which is parallel to the spring axis. The amount of the supporting surface remains constant, for example, with a limited rotation of the wire around a second direction of rotation counter to the first direction of rotation.

In yet another embodiment, the wire includes at least one formed on section on the side relative to the spring axis, for example, a flat formed on section.

In yet another embodiment, the wire is made of spring steel.

In yet another embodiment, the torque transmission device is designed as a dual mass flywheel or as a torsional vibration damper.

Generally speaking, the torque transmission device can be designed as a torsional vibration damper and/or as a dual mass flywheel and/or be arranged on and/or in a hydrodynamic torque converter, on and/or in a clutch device, for instance, a wet-running clutch, on and/or in a dual clutch device.

### BRIEF DESCRIPTION OF THE DRAWINGS

The nature and mode of operation of the present invention will now be more fully described in the following detailed description of the invention taken with the accompanying drawing figures, in which:

FIG. 1 is a representation of a wire cross-section of a wire of a helical spring according to a previously known embodiment;

FIG. 2 is a representation of a wire cross-section of a wire of a helical spring in an embodiment of the present invention; and,

FIG. 3 shows the characteristic curvature of the contact pressure between a. helical spring in an embodiment of the present invention and a spring hanger component, depending on the proportion between the second and first wire radius.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary, it is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

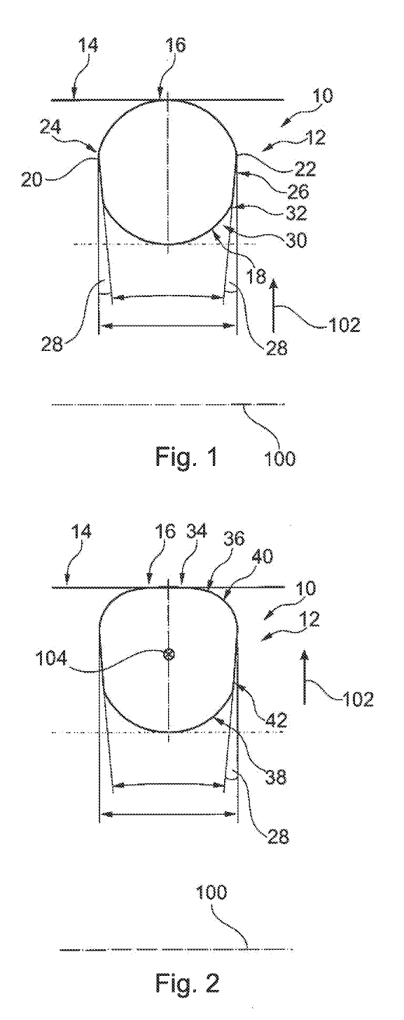

A cross-sectional representation of wire 10 of helical spring 12 according to a previously known embodiment is illustrated in FIG. 1. In it, wire 10 is spirally wound around spring axis 100 to form helical spring 12. The exterior of helical spring 12 is delimited by spring hanger component 14 relative to radial direction 102, where spring hanger component 14 is designed flat in the region of supporting surface 16 between helical spring 12 and spring hanger component 14, Looking at the cross-section, wire 10 of helical spring 12 has a circular design with wire radius 18 representing the circumference of the circle. Wire 10 is formed on to side faces 20, 22 present on both sides of wire 10 in the direction of spring axis 102 in such a way that wire cross-section includes flat regions 24, 26. Laterally formed on flat regions 24, 26 are tapered in the direction of spring axis 102 by angle 28, for example, by an angle of approximately 10 degrees.

This helps reduce the load exerted onto helical spring 12 as soon as the coils of the helical spring bottom out, i.e., if two wires arranged adjacent to each other in the direction of spring axis 100 come into contact with each other. The transition from circular section 30 of the wire circumference to flat, formed on region 24, 26 is created by rounding 32 having a transitional radius, which is smaller than the wire radius.

FIG. 2 shows a representation of a wire cross-section of wire 10 of helical spring 12 in an embodiment of the invention. Helical spring 12 includes wire 10, which is wound around spring axis 100, where wire 10 is formed on to exterior region 34 along spring axis 100 relative to radial direction 102. Formed on part 36 can be attached on helical spring 12 in sections in the direction of spring axis 100, but also across the entire length in the direction of spring axis 101). In addition, the wire cross-section of wire 10 is essentially circular and the circumference of the wire cross-section is described by first wire radius 38. Formed on part 36 is round in sections in the direction of the circumference of the wire cross-section and can he described by second wire radius 40, where first wire radius 38 and second wire radius 40 are different. Specifically, first wire radius 38 is smaller than second wire radius 40; for example, second wire radius 40 is greater than or equal to three times first wire radius 38.

This helps reduce the contact pressure of helical spring 12 on spring hanger component 14, which radially delimits the exterior of helical spring 12. Contact area 16 formed in the radially exterior region of helical spring 12 between wire 10 of helical spring 12 and spring hanger component 14 is enlarged relative to a wire with a completely circular cross-section. This likewise helps reduce the wear of wire 10 of helical spring 12.

An advantage of formed on part 36 described in the radially exterior region of helical spring 12 by means of second wire radius 40 relative to a flat formed on part in the region is achieved with the amount of contact area 16, which is larger if wire 10 is rotated around axis 104 pointing perpendicular to the wire cross-section and constant if the rotation of wire 10 is limited. If wire 10 rotates around axis 104, for example, if helical spring 12 is compressed or released, then contact area 16 is defined by the circumference of the wire cross-section in the region of formed on part 36 with limited rotation, the region being described by second wire radius 40 and the outline of spring hanger component 14 in the adjacent area, where the amount of contact area 16 ideally remains constant with limited rotation.

Furthermore, wire 10 has flat formed on part 42 laterally relative to spring axis 102 on both sides, the formed on part tapering off in the direction of spring axis 100 by angle 28.

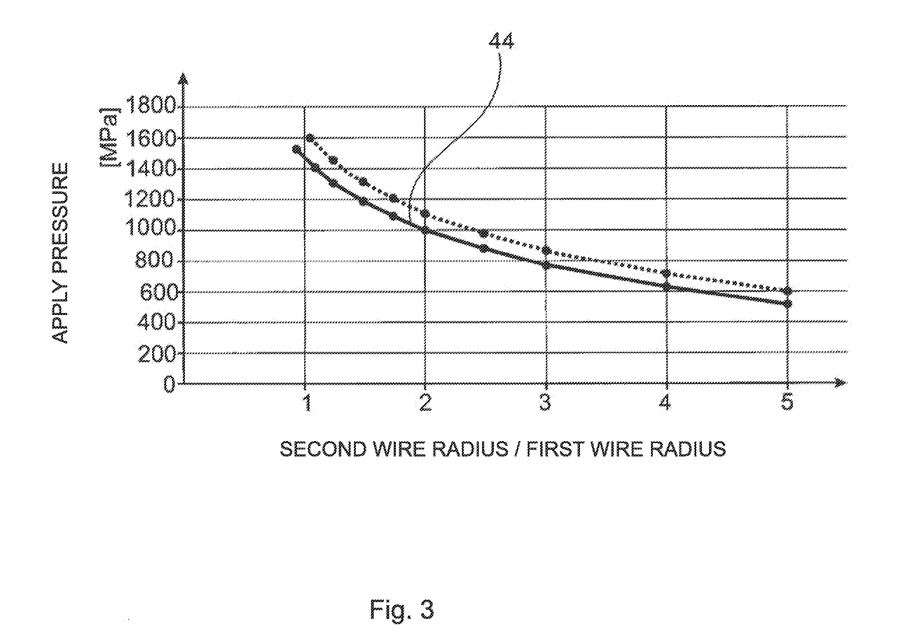

FIG. 3 shows characteristic curvature 44 of the contact pressure between a helical crew in an embodiment of the invention and a spring hanger component, depending on the proportion between the second and first wire radius, the contact pressure being characteristic for the contact. It illustrates the decrease of the contact pressure as the proportion between the second and the first wire radius increases. Consequently, the perfect situation with a rotated position of the wire around an axis perpendicular to the area of the wire cross-section would be an extensive, flat formed on part, provided that the spring hanger component is likewise formed in the region of the formed on part of the wire. However, this scenario does not take into account that the contact area would decrease sharply as soon as the wire is brought into a second rotated position. This fact is accounted for with the formed on part provided in the radially exterior region of the wire, which can be described by the second wire radius, where the amount of the contact area does not decrease significantly, even if the wire is rotated, and ideally remains constant within a certain rotational range.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present

What is claimed is:

1. A torque transfer device in a drive train, comprising:
an input component, which can rotate around a rotational axis and can be connected to a drive side;
an output component, which is capable of limited rotation in relation to the input component counter to the action of at least one helical spring and which can be connected to an output side; and,
a spring hanger component, which radially delimits the exterior of the helical spring, wherein the helical spring has a wire which is wound around a spring axis, wherein sections of the wire are formed on to a radially exterior region in relation to the rotational axis along the spring axis, wherein the cross-section of the wire is essentially circular and the circumference of said cross-section can be described by a first wire radius and whereby some sections of the molded region around the circumference of the wire cross-section are circular and can be described by a second wire radius, wherein the first wire radius and the second wire radius are different from one another.

2. The torque transmission device as recited in claim 1, wherein the first wire radius is smaller than the second wire radius.

3. The torque transmission device as recited in claim 2, wherein the second wire radius is greater than or equal to three times the first wire radius.

4. The torque transmission device as recited in claim 1, wherein the helical spring is designed as a bow spring or as a compression spring.

5. The torque transmission device as recited in claim 1, wherein the spring hanger component comprises a curvature in one section radially facing the helical spring, said curvature matching the second wire radius.

6. The torque transmission device as recited in claim 1, wherein a supporting surface is formed between the spring hanger component and the formed on wire, wherein the amount of the supporting surface remains constant in an axis which is parallel to the spring axis in a first direction of rotation if the rotation of the wire is limited relative to the spring hanger component.

7. The torque transmission device as recited in claim 6, wherein the amount of the supporting surface remains constant with a limited rotation of the wire around a second direction of rotation counter to the first direction of rotation.

8. The torque transmission device as recited in claim 1, wherein the wire comprises at least one formed on part on the side relative to the spring axis.

9. The torque transmission device as recited in claim 1, wherein the wire is made of spring steel.

10. The torque transmission device as recited in claim 1, wherein the torque transmission device is designed as a dual mass flywheel or as a torsional vibration damper.
